(19) United States
(12) Patent Application Publication
(10) Pub. No.: US 2023/0084525 A1
(43) Pub. Date: Mar. 16, 2023

(54) SEED POD ASSEMBLY AND ROTARY AEROPONIC APPARATUS AND METHOD

(71) Applicant: HELIPONIX, LLC, Evansville, IN (US)

(72) Inventors: Scott MASSEY, Evansville, IN (US); Ivan BALL, Evansville, IN (US)

(21) Appl. No.: 17/790,275

(22) PCT Filed: Jan. 6, 2021
(86) PCT No.: PCT/US21/12281

§ 371 Date: Jun. 30, 2022

Related U.S. Application Data
(60) Provisional application No. 62/957,353, filed on Jan. 6, 2020.

(51) Int. Cl. A01G 31/02

(52) U.S. Cl. CPC A01G 31/02; A01G 2031/006

(57) ABSTRACT

A seed pod assembly that has a pod defining an interior region and configured to support contents therein, a grow media positioned at least partially within the interior region, a plant seed positioned at least partially within the interior region, and a lid coupled to the pod to contain the plant seed within the interior region. The pod is sized to be positioned in an opening of a plant growing apparatus to allow water and nutrients to reach the plant seed or be released from within the pod.

### CROSS-REFERENCE TO RELATED APPLICATION

This application is a national phase entry of International Application No. PCT/US21/12281 filed on Jan. 6, 2021 and claims the benefit of U.S. Provisional Application No. 62/957,353 filed Jan. 6, 2020 the contents of which are incorporated herein in entirety.

### TECHNICAL FIELD

This invention relates generally to an aeroponic system and more specifically to an automated rotary aeroponic system.

### BACKGROUND

Gardening and farming edible produce is becoming increasingly important as the human population continues to grow and the available resources for conventional farming are reduced. More specifically, conventional farming requires large, open fields that allow a seed for a crop to be deposited in a nutrient rich soil. The seed requires the proper access to the sun, water, and any other nutrients not sufficiently available in the soil. Conventional farming is two-dimensional wherein the fields are substantially planar and only one layer of crop is typically planted in the field. Accordingly, the typical farm requires large areas of land with ample access to the sun.

Further still, only certain areas of the world provide the proper climate to cultivate certain crops. For example, the Midwestern United States may provide a climate that is ideal for crops like corn and soybeans. However, the climate in Brazil may be better suited for producing coffee and citrus fruits. Accordingly, conventional farming is limited at least by the availability of land and the climate of the region to be farmed.

Flat growing operations suffer from canopy formation, which prevents the lower leaves from receiving full light contact. The formation of a canopy often substantially restricts the plant growth because of the reduced exposure to the light source.

Accordingly, there is a need for a system that easily and efficiently creates an environment conducive to plant growth. Further still, there is a need for a system that can be implemented in urban environments to provide access to fresh crops when the proper land or climate conditions are not available naturally. The present disclosure provides several teachings that address the above concerns.

### SUMMARY

One embodiment is a seed pod assembly that has a pod defining an interior region and configured to support contents therein, a grow media positioned at least partially within the interior region, a plant seed positioned at least partially within the interior region, and a lid coupled to the pod to contain the plant seed within the interior region. The pod is sized to be positioned in an opening of a plant growing apparatus to allow water and nutrients to reach the plant seed or be released from within the pod.

In one example of this embodiment, the pod has support segments separated by at least one opening, wherein the opening allows water, plant roots, and nutrients to enter and exit the interior region.

Another example of this embodiment includes a filter positioned along at least a portion of walls of the interior region to provide a filter barrier between the interior region and a surrounding environment. As part of this example, the grow media and plant seed are positioned at least partially within the filter in the interior region.

Another example of this embodiments has additives in the interior region, wherein the additives are one or more of fertilizer, pH buffers, microbes, pesticides, adjuvants, animal repellant, soil enhancer, soil enricher, bone meal, plant growth hormones, cinnamon, sand, moisture absorbent, ribose, microbial inoculants, thermal retaining mass, detergent, cleaning solution, vinegar, hydrogen peroxide, soap, and fungicides.

Yet another example has a seed positioning member positioned around the plant seed and configured to hold the plant seed in a specific location in the interior region. In part of this example, the seed positioning member is formed of a different material than the grow media. In another contemplated part of this example, the seed positioning member is formed of foam.

Another example of this disclosure has a wrap around the seed pod assembly, the wrap configured to entirely surround the seed pod assembly and protect the contents of the seed pod assembly from the surrounding environment until the wrap is removed before the seed pod assembly is placed in the opening of the plant growing apparatus.

In another example, the interior region has an additive layer. In part of this example, the additive layer is positioned between two grow media layers. In a different part of this example, the additive layer is in contact with the plant seed.

In another part of the example having a filter, a portion of the filter is positioned at least partially between the lid and the pod and the lid is coupled to the pod to at least partially retain the filter therein.

Another example of this embodiment includes a retention tab coupled to or formed from the pod and configured to at least partially overlap a wall defining the opening when positioned therein. In part of this example, the retention tab has an inward taper configured to frictionally engage the wall of the opening when positioned therein. Another part of this example includes a radial tab extending radially away from a pod axis, the retention tab being positioned at least partially adjacent to the radial tab. In this part, the retention tab extends from a surface of the radial tab.

Another example of this embodiment includes an identifier configured to identify the type of plant seed in the seed pod when the seed pod is positioned in the opening of a plant growing apparatus. In one part of this example, the identifier is on the lid. In another part of this example, the identifier is an RFID tag. In this part, the RFID tag is positioned on a radial tab extending radially away from a pod axis.

In another example of this embodiment, one or more of the pod and the lid have a color configured to be associated with a corresponding opening of the plant growing apparatus.

Another embodiment of this disclosure is a method for forming a seed pod assembly. The method includes positioning a filter in an interior region of a pod, inserting a first grow media layer into a cavity of the filter in the interior region of the pod, placing a plant seed in the cavity of the filter on the first grow media layer, inserting a second grow media layer into the cavity of the filter adjacent to the plant seed, and coupling a lid to a top portion of the pod.

One example of this embodiment includes adding an additive mixture and a third grow media layer wherein the additive mixture is positioned between the first grow media layer and the third grow media layer. In part of this example, the additive mixture is one or more of fertilizer, pH buffers, microbes, pesticides, adjuvants, animal repellant, soil enhancer, soil enricher, bone meal, plant growth hormones, cinnamon, sand, moisture absorbent, thermal retaining mass, ribose, microbial inoculants, detergent, cleaning solution, vinegar, hydrogen peroxide, soap, and fungicides.

In another example of this embodiment the placing a plant seed step includes positioning the plant seed in a seed positioning member to hold the plant seed in the desired orientation within the interior region, the seed positioning member being a different material than the first and second grow media layer.

Yet another example includes compressing the contents of the interior region into the filter cavity as the lid is coupled to the top portion of the pod. Another example of this embodiment includes wrapping the seed pod assembly with a material wrap to completely seal the interior region of the seed pod assembly from the surrounding environment. In yet another example, the coupling the lid to the top portion of the pod step comprises melting at least a section of the filter between the lid and the pod in a sandwich-type configuration wherein the materials of the filter melt into the pod.

### DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is an elevated perspective view of a plant growing apparatus;

FIG. 2 is an elevated perspective view of the plant growing apparatus of FIG. 1 with a door removed;

FIG. 3 is an elevated perspective view of the plant growing apparatus of FIG. 2 with a drawer face removed;

FIG. 4 is an elevated perspective view of the plant growing apparatus of FIG. 2 with a drawer in a partially opened position;

FIG. 5 is a bottom elevated perspective view of the plant growing apparatus of FIG. 1 with several components removed;

FIG. 6 is a front section view of the plant growing apparatus of FIG. 1;

FIG. 7 is a bottom section view of the plant growing apparatus of FIG. 1;

FIG. 8 is a back elevated perspective view of the plant growing apparatus of FIG. 8 with a back panel removed;

FIG. 9 is a partial side section view of the plant growing apparatus of FIG. 1;

FIG. 10 is another partial side section view of the plant growing apparatus of FIG. 1;

FIG. 11, is another partial side section view of the plant growing apparatus of FIG. 1;

FIG. 11b is partial side section view of another embodiment of the plant growing apparatus of FIG. 1;

FIG. 12 is an isolated bottom perspective view of a drive system of this disclosure;

FIG. 13 is an exploded perspective view of growth rings from the plant growing apparatus of FIG. 1;

FIG. 14 is a side view of a growth ring from the plant growing apparatus of FIG. 1;

FIG. 15 is a section view of the growth ring of FIG. 14;

FIG. 16 is an exploded view of a seed pod assembly; and

FIGS. 17a and 17b are another embodiment of a seed pod assembly.

Corresponding reference numerals are used to indicate corresponding parts throughout the several views.

### DETAILED DESCRIPTION

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

A plant growing apparatus and method are generally explained in International Publication No. WO 2018/068042 and the detailed description and figures of that publication are incorporated herein by reference. Similarly, U.S. Provisional Application No. 62/701,908 describes an automated plant growing system and the contents of that application are incorporated herein by reference.

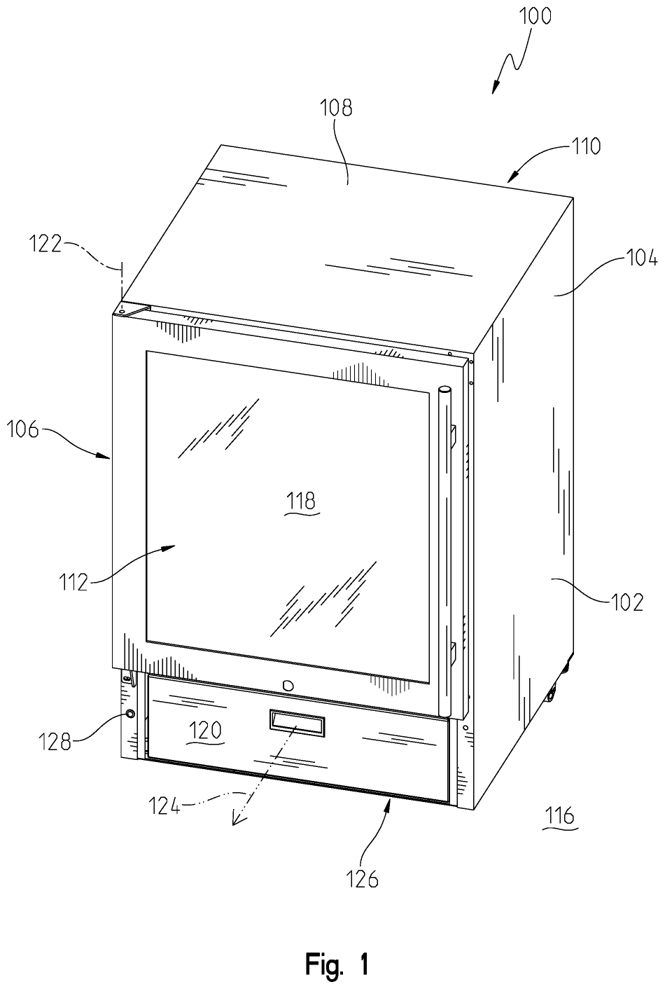

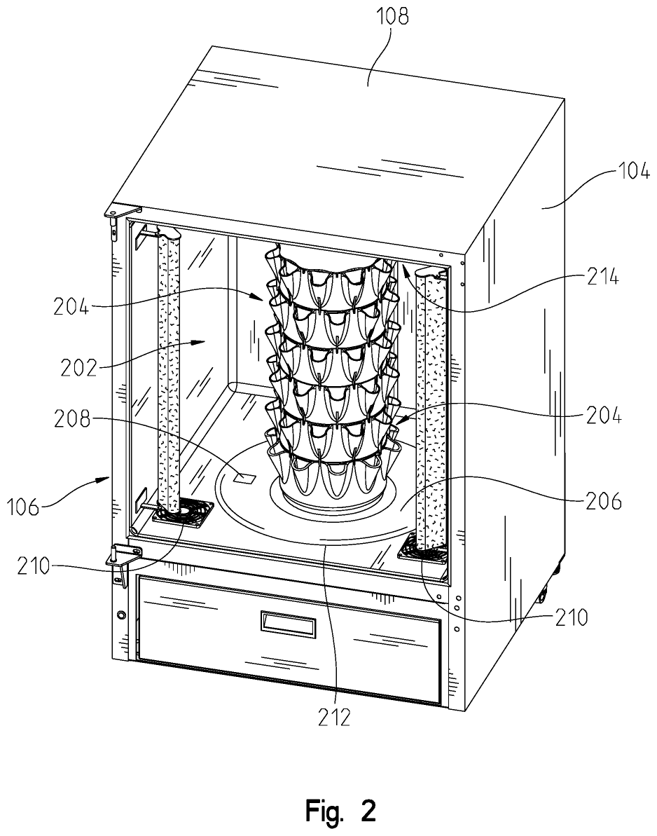

Referring now to FIG. 1, a plant growing apparatus 100 is illustrated. The plant growing apparatus 100 can be an enclosure that provides a climate-controlled interior 202 or cultivation chamber that houses at least one plant housing assembly 204. The growing apparatus 100 may have one or more panel 102 that surround the interior 202. In the non-exclusive embodiment of FIG. 1, the plant growing apparatus 100 may be substantially rectangular in shape and have a first and second side panel 104, 106, a back panel 110, front panels 112, a top panel 108, and bottom panels 114. Further still, in one embodiment the plant growing apparatus 100 may have receiving ports for a forklift or the like transport vehicle for ease of transportation.

While a rectangular plant growing apparatus 100 is illustrated, this disclosure is not limited to such a configuration. Rather, any three-dimensional geometric shape may be used to separate the interior 202 from a surrounding environment 116. More specifically, the plant growing apparatus 100 may have a cylindrical, hexagonal, octagonal, triangular, or the like cross-section and this disclosure considers any shape of growing apparatus 100. Accordingly, the term “panel” may not be limited to a planar member but may also include curved, helical, or cylindrical elements as well.

The growing apparatus 100 may be sized and shaped to fit in a standard residential kitchen or the like area. Further still, the growing apparatus 100 may be sized and shaped to fit in industrial commercial applications such as warehouses and restaurants, among others. For example, in one non-exclusive embodiment the plant growing apparatus 100 is sized to fit into a standard base cabinet opening wherein the plant growing apparatus 100 can be positioned under a countertop. Further still other configurations considered herein may be sized and shaped like a standard refrigerator or the like wherein the plant growing apparatus 100 may occupy a similar space as a standard sized refrigerator. Further still, the teachings of this disclosure can be implemented in larger structures like buildings. In this embodiment, the plant growing apparatus 100 may be an entire building, wall(s) of a building, or the interior 202 may be the inside of the building. In yet another example, a shipping container could be repurposed with a plant housing positioned therein to make a modular hydroponic farm that can be easily transported. Accordingly, this disclosure considers implementing many different dimensions for the plant growing apparatus 100.

In one aspect of this disclosure, the front panels 112 may include a door 118 and a drawer 120. The door 118 may be rotationally coupled to the remaining components of the plant growing apparatus 100 about a door axis 122. Accordingly, the door 118 may rotate about the door axis 122 between a closed position as illustrated in FIG. 1 and an opened position. In the closed position, the door 118 and remaining panels 102 may substantially isolate the interior 202 from the surrounding environment 116. Alternatively, in the opened position, the door 118 may allow a user to access the interior region 202 from the surrounding environment.

In one non-exclusive example one or more of the panels 102, 104, 106, 108, 202 or any other panel having a surface facing the interior 202. The panels may have a reflective material at least partially along the interior surface. Further, one or more LEDs may be embedded in or on the panel or panels that can selectively provide supplemental intracanopy lighting. In this embodiment, the panel or panels may use a semi, or highly reflective mirror surface to recycle light back to the interior 202 to promote plant growth. Further, the LEDs may selectively adjust an angle of illumination, intensity, orientation, position, temperature, and/or spectra based on a rotation position of the plant housing assembly 204. In this embodiment, the LEDs may also be evenly spaced to act as a passive heat sink to facilitate cooling the LEDs during use.

LEDs may also be positioned in the corner(s) of the interior 202 and one or more of the LEDs discussed herein may be selectively controlled to simulate rotation of the plant housing assembly 204 through oscillating brightness of the LEDs. Oscillating the LEDs may promote accelerated growth rates among other things. In another embodiment, the LEDs may be flat panels mounted onto the walls, ceilings, and/or the floor for homogenous lighting from all sides.

In yet another aspect of this disclosure, any portion of the panels directed towards the interior region 202 may have a reflective material to ensure any plants positioned in the housing assembly 204 intake the majority of the photons of light emitted. This configuration may maximize the photosynthetic potential of the energy provided by the grow lights. More specifically, the surfaces of the panels facing the interior region may have a high-gloss white or reflective material thereon. The white or reflective material could reflect any light that does not land on the leaves of plants in the housing assembly 204 back to the plants to prevent wasted light energy.

In yet another aspect of this disclosure, the interior 202 may be substantially sealed from the surrounding environment to allow the humidity and pressure of the interior 202 to be selectively controlled. Low humidity environments may hinder plant growth by drying out the stomata which are required to be open for the gaseous exchanges needed in photosynthesis. Accordingly, one aspect of this disclosure utilizes a sealed, positively pressurized interior 202 to provide the dual benefit of preventing the entry of pests into the interior 202 and maintaining the optimal humidity for photosynthesis. In other words, the humidity and/or pressure of the interior 202 may be selectively controlled to ensure optimal plant growing conditions therein. Further still, CO2 levels of the interior may be monitored and modified to provide improved growing conditions.

In one aspect of this disclosure, the door 118 may have a door switch 302 positioned to identify when the door 118 is not in the closed position. The door switch 302 may be a reed switch or any other type sensor capable of identifying the position of the door 118. In one non-exclusive example of this disclosure, the door switch 302 may communicate with a controller 726 to identify when the door is not in the closed position. Further, the controller 726 may implement a response, such as dimming a light source 304, shutting off the pump, valve, motor, or any other components, when the door 118 is no longer in the closed position. Further, the system may decrease, or increase the light brightness to more closely resemble the natural light intensity curve of the sun's rotation through the sky to not interfere with the circadian rhythm of the apparatus's owner or operator. There may also be auto-tinting glass, blinds, or other means to limit light transparency through the door partially, or entirely to minimize light pollution.

Similarly, the drawer 120 may be movable between the closed position of FIG. 1 and an opened position. More specifically, the drawer 120 may move axially along a drawer axis 124 between the closed and opened positions. A drawer switch 306 may also be coupled to the plant growing apparatus 100 and communicate with the controller 726 to identify when the drawer 120 is not in the closed position. Further, the controller 726 may implement a response, such as restricting a pump flow, or other functions when the drawer 120 is no longer in the closed position.

The drawer 120 may further have a locking mechanism 308, such as a solenoid lock pin, electromagnetic switch, or other mechanical apparatus positioned to selectively restrict the drawer 120 from moving from the closed position to the opened position. The controller 726 may communicate with the locking mechanism 308 to restrict the drawer 120 from moving to the opened position when the controller 726 determines a fluid flow is being implemented in the plant growing apparatus 100. As will be described in more detail herein, the drawer 120 may provide access to a reservoir 310 positioned therein. The reservoir 310 may be sized to capture and contain fluid distributed through the plant growing apparatus 100. When the drawer 120 is in the opened position, the reservoir 310 may no longer be positioned to properly capture fluid draining from the plant housing assembly 204. Accordingly, in one non-exclusive example of this disclosure the controller 726 may maintain the locking mechanism 308 in the locked position until the plant housing assembly 204 has had sufficient time to drain fluid therefrom into the reservoir 310.

The drawer 120 may be part of a second region below the interior 202. The second region may recirculate air over the reservoir 310 to cool heated air before returning the air to the interior through fans 210. In this configuration, air blowing out of the interior 202 acts as a dryer for components in the second region. In other words, the air flow pattern in the second region may be generally from a back fan to a front fan to keep the bottom region dry and/or cool the air as it passes over the reservoir 310. These fans may have filters on the fan inlets and/or outlets to the growth chamber. The fan filters may be replaceable and have activated carbon, desiccants, or other reactive inputs to remove humidity, odors, and microbes from the air flow to keep the environment sanitary. Additionally, the outlet fan filter may remove humidity from the exiting air which would make it dryer, evaporate water faster over the reservoir, and result in a cooler system through evaporation. One embodiment of this disclosure applies a chilled coil in the outlet fan that condenses water back into the reservoir to recollect this humidity, and keep the system cool. Maintaining lower temperatures may prevent algae or other pathogen outbreaks in the plant growing apparatus 100.

Next to the drawer 120 may be an input 128. The input 128 may be a button, touch screen, or any other user selectable device that allows the user to provide instructions to the controller 726. In one non-exclusive example, the input 128 may be a button and the user may press and/or hold the button for a preset time limit to reset or otherwise power down the plant growing apparatus 100. While the input 128 is illustrated next to the drawer 120, other locations for the input 128 are also considered herein. For example, the input 128 may be coupled to any panel of the plant growing apparatus 100. Further still, the input 128 may be positioned inside wherein the drawer 120 must be opened to access the input 128. Further still, the input 128 may communicate any desired user preference to the controller 726 and the example provided is not meant to be exhaustive.

The reservoir 310 may sit on a drawer pan 602 to be moved between the opened and closed position. In one aspect of this disclosure, the drawer pan 602 may be a substantially fluid tight reservoir itself. More specifically, the drawer pan 602 may have a base portion and surrounding side portions that create a fluid tight sub-reservoir in which the reservoir 310 may be placed. In this configuration, the drawer pan 602 may be capable of capturing and containing a volume of fluid when the reservoir 310 is not positioned therein but fluid is dripping or otherwise flowing from the plant housing assembly 204.

The drawer pan 602 may be slidably coupled to the plant growing apparatus 100 along the drawer axis 124 via one or more slider 604. The sliders 604 may be positioned to allow the drawer pan 602 to move axially along the drawer axis 124 between the opened position and the closed position. Further, in one aspect of this disclosure the sliders 604 may have a push-to-open feature. The push-to-open feature may allow the user to transition the drawer pan 602, and in turn the reservoir 310 when placed thereon, from the closed position to the opened position by pressing the drawer 120 in an open direction 126. Once the drawer 120 is moved in the open direction 126, the sliders 604 may automatically transition the drawer 120 to a partially or fully opened position without further user contact.

The reservoir 310 may also have a tapered upper lip that is configured to minimize fluid splashing over the sidewalls of the reservoir 310. The tapered upper lip may have a profile that directs any fluid traveling up the sidewall towards the center of the reservoir 310 instead of over the sidewall. The tapered upper lip may be coupled to, or formed from, the upper edge of the reservoir 310 and substantially minimize the amount of fluid that escapes the reservoir when sloshed against the sidewalls. Further a gasket may be positioned between the upper edge of the reservoir 310 and the tapered upper lip. The gasket may be made of silicone, rubber, any other material that can create a watertight seal between these two components. Mechanical fasteners in the form of a nut and bolt, snap fit clamps, or a stretchable band, among others, to keep the two components compressed against the reservoir gasket may be utilized to prevent splashing.

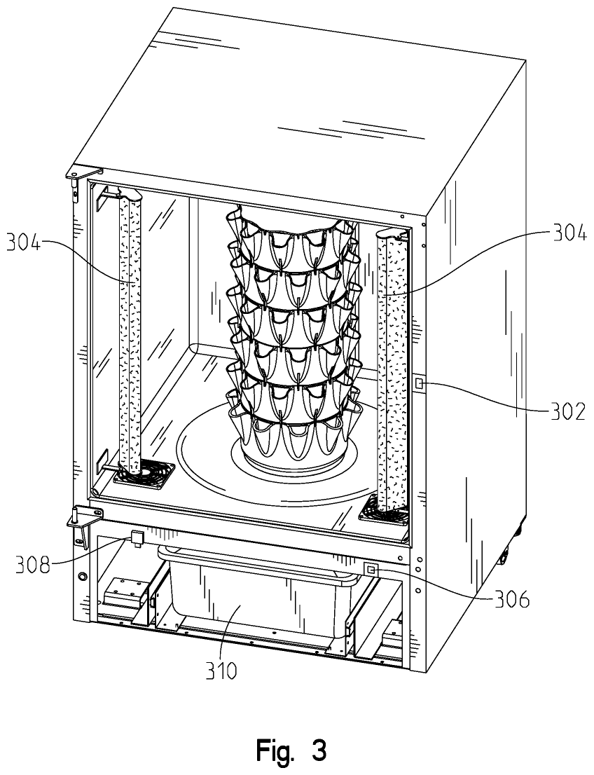

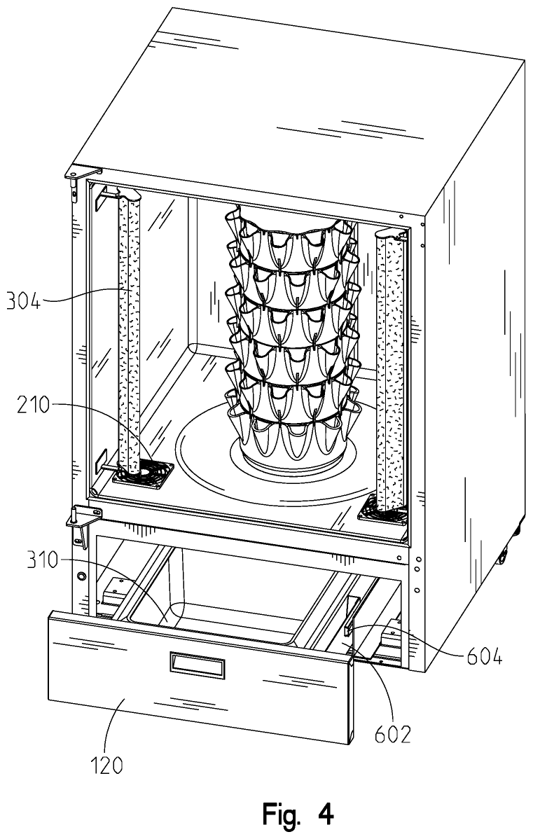

To additionally reduce reservoir splashing, the reservoir 310 may have one or more baffles. The baffles may be on one or more surfaces of the reservoir to increase the number of surface faces the water flow must encounter before reaching the opposite end of the reservoir 310, thereby reducing splashing. The baffles may be a single piece of metal bent in opposite directions, a baffle ball, or any other method known in the art. Referring now to FIG. 3, the plant growing apparatus 100 is illustrated with the door 118 removed to further illustrate the components of the interior 202. More specifically, the interior 202 may be defined by an inner surface of the door 118 (when the door is closed), a portion of an inner surface of the first side panel 104, a portion of an inner surface of the second side panel 106, an inner surface of the top panel 108, and an inner surface of a base plate 206. In one aspect of this disclosure, the base plate 206 may form a bottom support for the plant housing assembly 204. The base plate 206 may act as a barrier at least partially separating the interior 202 from the reservoir 310. Accordingly, the base plate 206 may substantially restrict debris and the like from falling from the plant harvesting assembly 204 and becoming positioned within the fluid of the reservoir 310.

In one aspect of this disclosure, the base plate 206 may have a fluid sensor 208 positioned thereon to determine whether any fluid is on the base plate 206. The plant housing assembly 204 may be configured to direct fluid through an interior passage 1202 to the reservoir 310. However, if the interior passage 1202 becomes clogged or otherwise obstructed, the fluid may flow out of the interior passage 1202 and become positioned on the base plate 206. Accordingly, the fluid sensor 208 may communicate with the controller 726 to identify when fluid has become positioned on the base plate 206. Further, in one non-exclusive example of this embodiment, the controller 726 may stop fluid flow through the interior passage 1202 of the plant housing assembly 204 when the fluid sensor 208 identifies fluid on the base plate 206 to prevent fluid spills or the like. In another embodiment, the base plate may catch and direct any spilled water towards the front, so the issue can be brought to the user's attention.

In one aspect of this disclosure, the base plate 206 may have one or more bends 212 or a shallow cone defined therein to allow the base plate 206 to be tapered towards a middle section. By tapering the base plate 206 via the bends 212, any fluid that becomes positioned thereon may flow towards the middle section. Further, the middle section may have at least one orifice or the like that allows fluid to transition from the interior 202 to the reservoir 310 through the base plate 206. With this orientation, the base plate 206 may direct fluid towards the middle section when fluid has unintentionally escaped the interior passage 1202 and become positioned thereon.

The base plate 206 may further have at least one blower or fan assembly 210 positioned thereon. The fan assembly 210 may be selectively engaged by the controller 726 to provide airflow between the interior 202 and the surrounding environment 116. More specifically, one or more fan assembly 210 may be providing airflow into the interior 202 while one or more fan assembly 210 may be exhausting airflow out of the interior 202.

In one aspect of this disclosure, each fan assembly 210 may have an insect resistant screen or the like positioned between the fan assembly 210 and the interior. The insect resistant screen may substantially restrict any insects from entering the interior through the fan assembly 210 and compromising the plants located therein. In one non-exclusive example, the insect resistant screen may be electrified to kill any insects that encounter the insect resistant screen. The fan assembly 210 may agitate the plant to build turgor pressure for more crisp plants, pollinate plants that require fertilization, or remove heat from the interior to name a few uses for the fan assembly 210. In yet another embodiment, a filter may be positioned along the fan assembly 210 to filter air passed there through. The filter may be designed to remove humidity, undesirable odors, and/or prevent pathogens or pests from entering the cultivation chamber among other things. Further, the fan filters may be removable to be replaced as a cartridge. In this configuration, the filters may be provided on a subscription basis. The filter could be attached via mechanical fasteners such as screws, magnetic faces, threaded inserts, or friction fit profiles among other adapting techniques. The filters could be composed of biodegradable or compostable polymers that could rapidly decay once disposed. In yet another embodiment, the filter could include a screen that is inserted into a filter frame to secure the filter over the fan. In another aspect of this disclosure, fans of the fan assembly 210 may be positioned to blow air on the light source 304. More specifically, the light source 304 may provide the required light to any plants in the interior 210. The light source 304 may be an LED light assembly that has a heatsink or the like and requires cooling. The heat sink of the LEDs may be thermally connected to a loop as an anti-condensation system for the appliance doors like a refrigerator to prevent condensation. In this configuration, fans from the fan assembly 210 can direct airflow over the LED light assembly of the light source 304 to thereby cool the LED lights. In one non-exclusive example of this disclosure, there may be a light source 304 positioned on either side of the door 118 opening to thereby direct light towards the 204 plant housing assembly 204 and away from the door 118. In this configuration, the light source 304 may not substantially shine light out of the door opening and into the surrounding area.

As discussed herein, the fan assembly 210 may also have one or more fan that exhaust from the interior 210. The air exhausted from the interior 210 may carry various odors associated with plant fertilization and growth that are undesirable. Accordingly, in one aspect of this disclosure the exhaust fans of the fan assembly 210 may have an odor neutralizing filter thereon. The odor neutralizing filter may be any filter known in the art to reduce odor and in one non-exclusive example is a carbon filter.

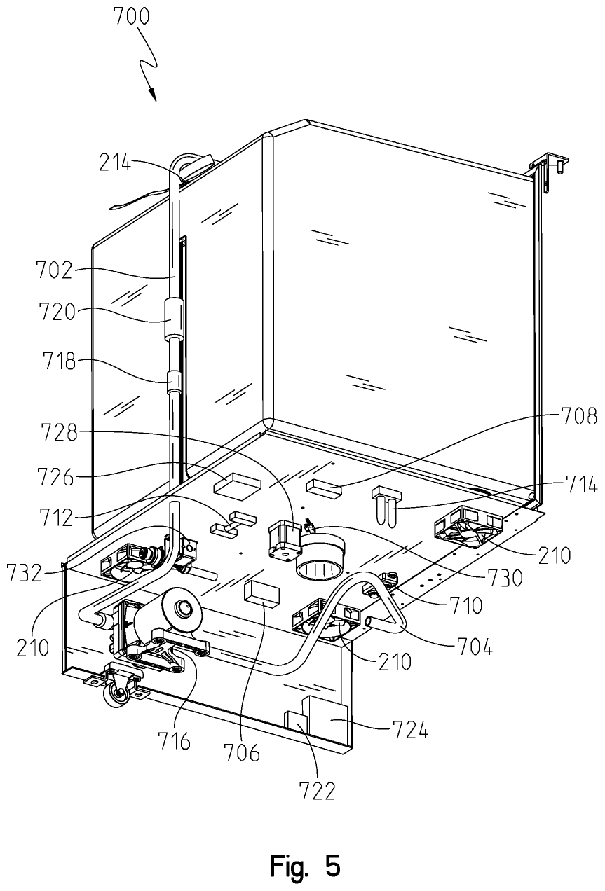

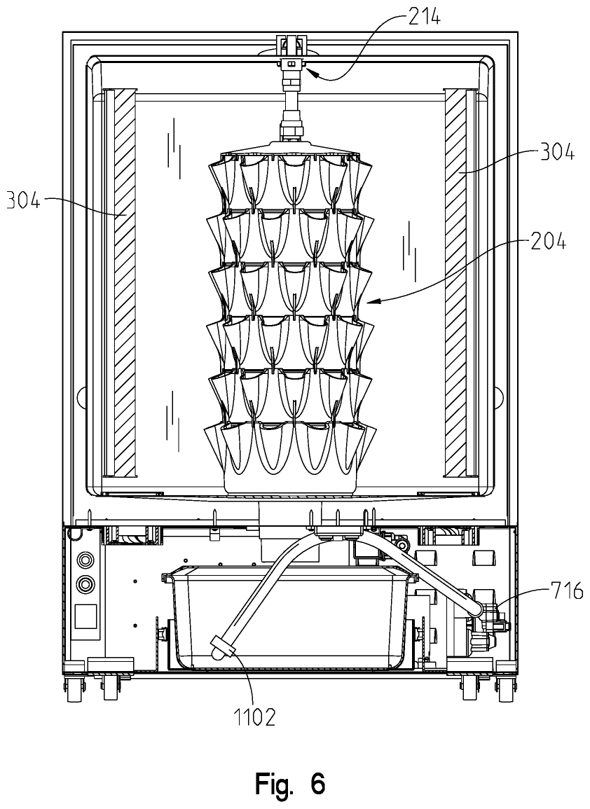

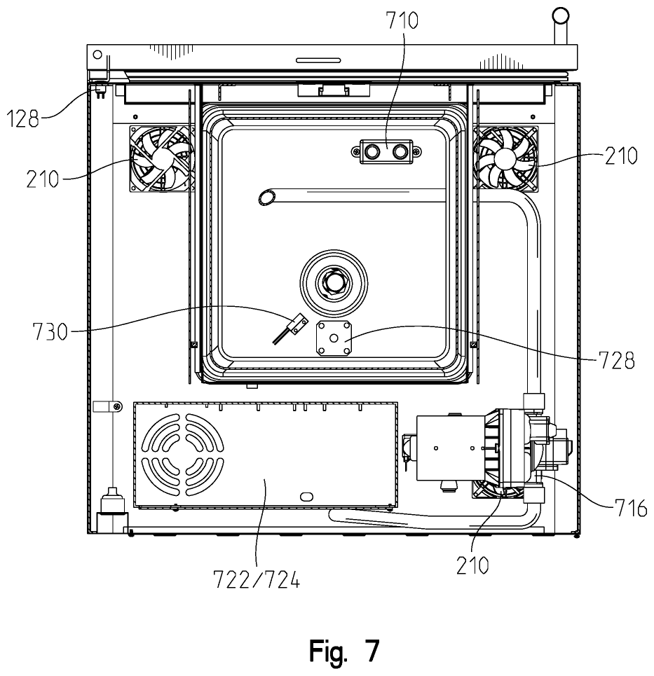

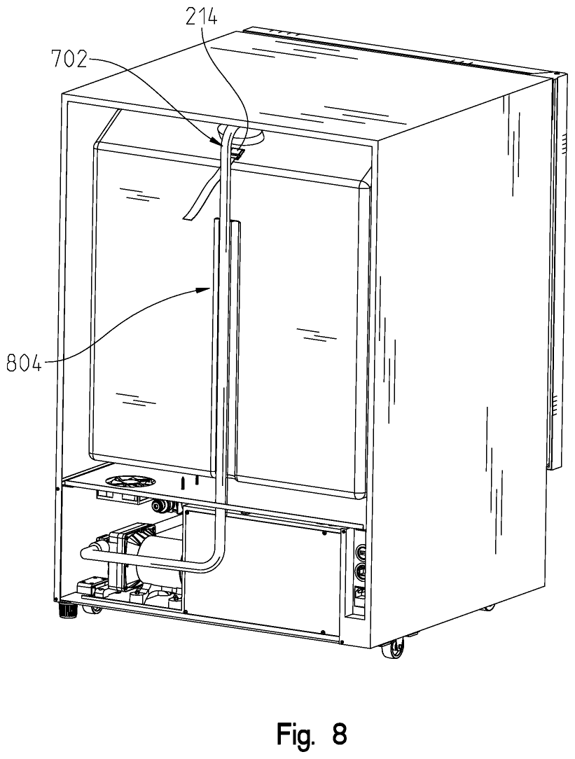

Referring now to FIG. 5, a bottom perspective view 700 is illustrated with many components removed to show components of the plant growing apparatus 100. In one non-exclusive embodiment, the fluid of the plant growing apparatus 100 may be monitored. More specifically, both the volume and quality of the fluid in the reservoir 310 and dispersed into the interior passage 1202 may be monitored to ensure the fluid conditions are optimal for plant growth.

More specifically, the plant growing apparatus 100 may have a fluid path 702 that directs fluid from a fluid inlet 704 positioned in the reservoir 310 to a nozzle 1302 that is at least partially positioned within the interior passage 1202. In one embodiment of this disclosure, the fluid system may include a water condenser 706, a nebulizer 708, a fluid level sensor 710, an ultraviolet (UV) light filter 712, anode probes 714, a pump 716, a flow meter 718, or a deionizer 720 to name a few non-exclusive examples. The fluid system may be configured to deliver the proper volume and quality of fluid to roots of any plants positioned in the plant housing assembly 204.

The pump 716 may be a high-pressure diaphragm pump that is positioned in line with the fluid path 702. The pump 716 may be capable of providing a fluid flow rate and pressure that corresponds with the nozzle 1302 to deliver fluid to the interior passage 1202. Further, the nozzle 1302 and pump 716 may be configured to deliver a mist of fluid to the interior passage 1202 at a velocity that is sufficient to degrade any biofilm forming therein without substantially harming any plant roots positioned therein. In one non-exclusive example, the nozzle 1302 may be capable of dispersing liquid in about 360 degrees to thereby ensure that biofilm is removed from all surfaces of the interior passage 1202. However, a centrifugal impeller driven pump among others may also be used.

Further still, the nozzle 1302 may be removably coupled to the fluid path 702 via a threaded or the like engagement thereto. In this configuration, if the nozzle 1302 is clogged or otherwise blocked with residue the user may remove the nozzle 1302 from the fluid path 702 and clean the nozzle 1302. Further still, the nozzle(s) may be formed of a material that restricts substantial residue build-up such as stainless steel or the like.

In one aspect of this disclosure, the nozzle 1302 may be axially repositionable along a plant axis 1204 to accommodate different height housing assemblies 204. For example, the positioning on the nozzle 1302 may be selectively repositionable to accommodate any number of growth rings 1206. However, there may also be consistent conduit columns that are not broken into segmented rings, or this may be vertically fastened column portions in another non-exclusive embodiment. More specifically, the nozzle 1302 may be coupled to a conduit assembly having a series of tubes concentrically fixed with diameters that correspond with one another to provide telescopic repositioning. The conduit assembly may have a threaded collar at the end to selectively fix the conduit assembly in a stationary position once the optimal length is set. Accordingly, the nozzle 1302 may be selectively repositioned, or angled, to accommodate different lengths. While a telescopic conduit assembly is described herein, in another embodiment the conduit assembly could be a solid, extending pipe with a flexible water conduit wrapped around a solid fixture. Accordingly, any repositionable assembly is considered herein for allowing the nozzle 1302 to be repositionable along the plant axis 1204.

While a high-pressure diaphragm pump is described herein, this disclosure contemplates utilizing any type of fluid pump. However, in one non-exclusive example the pump 716 is selected to limit the amount of heat added to the fluid by the pump 716. Accordingly, any fluid pump capable of providing the proper fluid pressure and flow to the fluid system without adding a substantial amount of heat is considered herein.

The flow meter 718 or switch may also be fluidly coupled to the fluid path 702 and configured to communicate a flow rate of the fluid through the fluid path 702 to the controller 726. The flow meter 718 may be any type of flow meter known in the art and the controller 726 may monitor the flow meter 718 to identify how efficiently the pump 716 is performing. More specifically, in one embodiment the controller 726 may monitor the flow meter 718 when the pump 716 is instructed to be providing fluid to the nozzle 1302. If the controller 726 instructs the pump 716 to provide fluid to the nozzle 1302, the controller 726 may then monitor the flow rate of the fluid through the fluid path 702 with the flow meter 718 to ensure that the fluid system is functioning properly. For example, if the controller 726 instructs the pump 716 to provide fluid to the nozzle 1302, but then identifies a flow rate with the flow meter 718 that is less than a flow threshold, the controller 726 may indicate a warning to the user or stop the fluid system. The reduced flow rate could be indicative of a clogged or malfunctioning pump 716 among other things.

In one aspect of this disclosure, the fluid path 702 may travel through a channel 804 defined in a back panel assembly. More specifically, the back panel 110 may be formed from an interior panel and an exterior panel that has insulation there between. The fluid path 702, along with electrical wiring for the electrical system, may travel along the channel 804 defined in the back panel 110. The channel 804 may be formed by placing a placeholder along the channel 804 before insulation is added between the interior and exterior panel. Then, after insulation is added between the two panels, the placeholder is removed and the channel 804 is exposed. The fluid path 702 and electrical wiring may then be positioned along the back panel 110 between the interior and exterior panels.

The fluid level of the reservoir 310 may also be monitored by the fluid level sensor 710 to ensure the reservoir 310 contains the proper volume of fluid. In one non-exclusive example, the fluid level sensor 710 may be an ultrasonic sensor positioned above the reservoir to identify the level of fluid therein. However, any type of fluid level sensor 710 is also considered, including an analog float switch, camera, or digital sensor among other things. The fluid level sensor 710 may communicate with the controller 726 to identify when the reservoir 310 requires more fluid. When the controller 726 identifies that the reservoir 310 is low, the controller 726 may engage a source to provide fluid thereto.

The source of fluid for adding fluid to the reservoir 310 may be any fluid source. In one non-exclusive example, the source of fluid may be a fluid line that is coupled to a local water system. In one non-exclusive example, a solenoid valve 732 may selectively provide fluid from the local water system to the reservoir 310 when low fluid levels are identified. Alternatively, one embodiment contemplated herein utilizes the water condenser 706 to condense water out of the surrounding atmosphere and direct it to the reservoir 310 when the controller 726 instructs it to do so. In this configuration, when the controller 726 identifies the reservoir 310 is low via the fluid level sensor 710, the controller 726 may engage the water condenser 706 to condense water from the surrounding atmosphere to thereby fill the reservoir 310 to the proper level.

In another embodiment, a device may distribute one or more substances into the reservoir 310. The substance(s) may be a powder; compressed disks; other pelletized items such as fertilizers, hydroponic microbial inoculants, pH catalysts, or sanitation catalysts; or any other substance or mixture of substances. The distributing device may be an actuated mechanism, such as an auger, solenoid coin slot, rotary portion divider, or another device that may regulate the applied amount over a period of time. In another embodiment, this distributing device could be a mixing reservoir that is dosed with water to mix the solution, and then the device distributes the mixed solution into the reservoir 310. In another embodiment, this distributing device could be a small dissolvable container placed into the growing environment or tower ports.

In one aspect of this disclosure, the fluid system may have one or more fluid filters therein. More specifically, the plant growing apparatus 100 may be specifically used for growing edible plants that are intended to be consumed. Accordingly, the cleanliness and sanitation of the fluid may be monitored by the fluid system. The nebulizer 708 may implement sound waves or the like that are specifically sized to break down bacteria within the fluid. The nebulizer 708 may be positioned at a location within the fluid system that causes the fluid therein to pass by the nebulizer 708 thereby exposing any bacteria to the sound waves produced by the nebulizer 708. In one embodiment, the fluid filter may be changed from the front of the aeroponic cultivation chamber without opening the drawer 120.

The UV light 712 may be another fluid filter positioned within the fluid system. The UV light 712 may be positioned above the reservoir 310 to expose the fluid contents of the reservoir 310 to UV light. The UV light 712 may emit light into the fluid of the reservoir to thereby destroy undesired microorganisms or bacteria that are located therein. In one non-exclusive example, the UV light 712 may be of a spectrum sufficient to kill e-coli, algae, or the like. In one aspect of this disclosure, the UV light 712 may be a UV LED such as UV-c, UV-A, and/or UV-B to give a few nonexclusive examples. Utilizing the UV LED may provide the benefits of UV light filtering without the risks associated with mercury gas filled tubes as used in UV t5 bulbs. The UV light 712 may be positioned above the reservoir 310 or directly therein. Further, the UV light 712 may run on a duty cycle to minimize the evaporation of water through the day.

Similarly, the anode probes 714 may be positioned within the fluid of the reservoir 310 or otherwise along the fluid path 702 to further purify the fluid therein. The anode probes 714 may include silver and copper anode probes that are positioned to sterilize the water when a current is supplied thereto. Further providing current to the silver and copper anode probes 714 may prevent bacterial outbreaks such as Legionella or the like in the fluid of the plant growing apparatus 100.

While several fluid cleansing devices are described herein, this disclosure contemplates utilizing any type of fluid cleansing system that may provide a more sterile and sanitary fluid in the fluid system. As described above, the plant growing apparatus 100 may frequently be used to grow edible plants for consumption. Accordingly, the fluid and interior 202 may be specifically designed to maintain a sanitary and food-safe environment as described herein.

A power supply 724 or the like may provide power to an electrical system of the plant growing apparatus 100. More specifically, the power supply 724 may be configured to be electrically coupled to an electric power supply, a solar panel, or any other known electrical power supply to provide power to the electrical system. In one no-exclusive example, the power supply 724 may be electrically coupled to a battery 722 or other energy storage device to thereby allow the power to be provided to the electrical system even when the power supply 724 is not coupled to a power source. The battery 722 may be charged when the power supply 724 is coupled to a power source and the stored power of the battery 722 may be utilized when the power supply 724 is no longer coupled to a power source.

The electrical system may provide power to the water condenser 706, nebulizer 708, fluid level sensor 710, UV light 712, anode probes 714, pump 716, flow meter 718, deionizer 720, light source 304, motor drive, and a camera 214 to name a few non-exclusive components of the electrical system. Further the controller 726 may selectively power the components of the electrical system to create an interior 202 that is conducive to efficient and plentiful plant growth.

The controller 726 may also be in communication with a plant motor 728 that is coupled to the plant housing assembly 204. The controller 726 may selectively power the plant motor 728 to rotate the plant housing assembly 204 about a plant axis 1204 to transition the plants being exposed to the light source 304. In another embodiment, the plant housing assembly 204 may be directly rotated without electricity, for example with a wind turbine or another apparatus. Further still, in one aspect of this disclosure a plant sensor 730 may be positioned to identify the rotation of the plant housing assembly 204. More specifically, the plant sensor 730 may be a reed switch that is positioned adjacent to a cammed rotation disk. The cammed rotation disk may have recessed portions that interact with the plant sensor 730 to communicate to the controller 726 that the plant housing assembly 204 has rotated a predefined amount. In one non-exclusive embodiment, the controller 726 may utilize the camera 214, to take and store or otherwise transmit a photo or video of the plant housing assembly 204 responsive to the rotational position of the plant hanging assembly 204 as identified by the plant sensor 730.

In yet another embodiment, a magnet in the plant housing assembly 204 may pass by a sensor coupled to the base plate 206 to identify the rotational orientation of the assembly 204. In another embodiment, the plant sensor 730 may be a mechanical switch that pushes up when it comes into contact with a recessed cavity on a corresponding surface to identify rotation. Yet another embodiment may utilize a photo sensor that sees a specific color or reflective material on the assembly 204. In one aspect of this embodiment, the camera 214 may identify specific colors or features on the assembly 204 to determine rotation. In yet another embodiment, the sensor 730 may be a laser, among other optical sensors, that are able to measure the distance change in a recessed cavity on a corresponding surface to identify rotation. Similarly, the sensor 730 may be a sonar sensor that is able to measure the distance in a recessed cavity on a corresponding surface to identify rotation. The sensor 730 may also identify a physical protrusion that switches a mechanical switch as it rotates by. Further still, the sensor 730 may be a rotary encoder. In yet another embodiment, the rotation of the assembly may be determined by counting the steps from a stepper motor and using a software algorithm to determine rotation based on a known gear ratio or other means to rotate a shaft, including but not limited to a belt drive or a direct drive motor among other considerations.

In one aspect of this disclosure, a weighted tip 1102 is illustrated on the fluid inlet 704. The weighted tip 1102 may be formed of a material that is heavy enough to cause the weighted tip 1102 to become positioned along a bottom portion of the reservoir 310 when positioned thereunder. In this configuration, the weighted tip 1102 may ensure that the fluid inlet 704 remains submerged in any fluid within the reservoir 310 to thereby substantially restrict air from being introduced into the fluid path 702. Further, the fluid inlet 704 and weighted tip 1102 may be positioned to easily transition into, and out of, the reservoir 310 as the drawer 120 is opened and closed. Alternatively, a bulkhead fitting could be coupled to a check valve to constantly pull fluids from the bottom of the reservoir 310. The check valve could prevent the reservoir 310 from leaking from the bulkhead fitting when the reservoir 310 is removed from the drawer 120

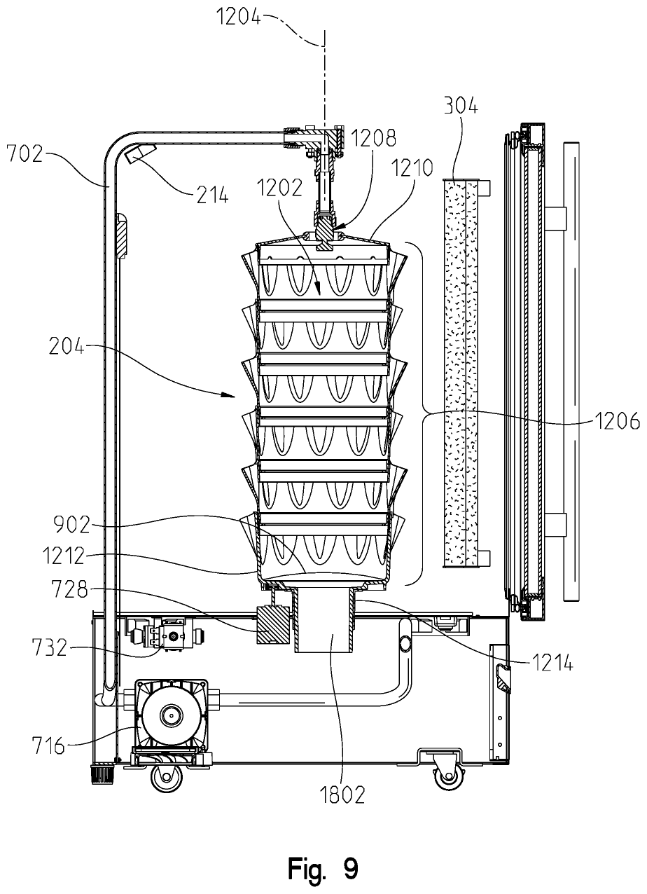

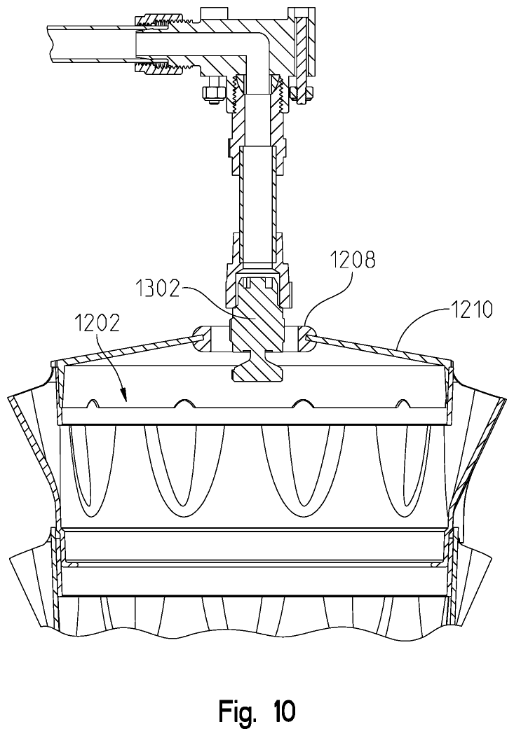

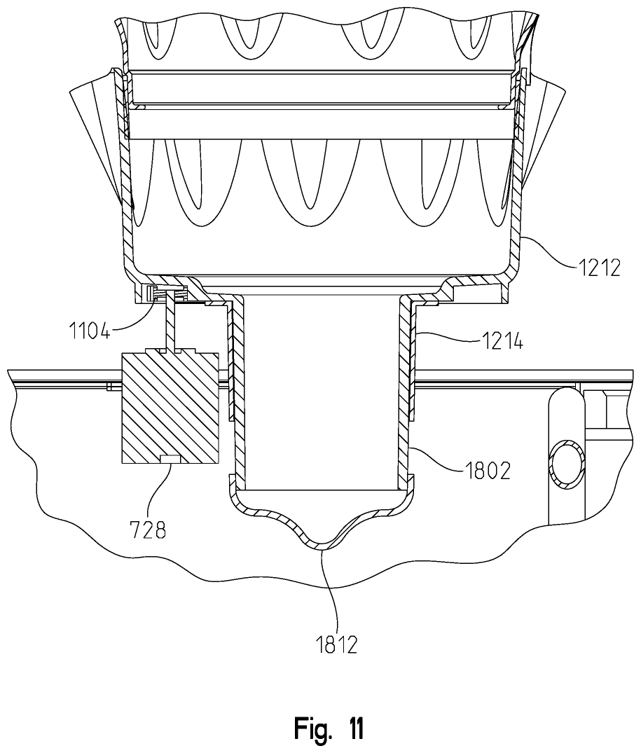

Referring now to FIG. 9, a half section view of a portion of the plant housing assembly 204 is illustrated. The plant housing assembly 204 may include a plurality of growth rings 1206 coupled to one another to define the interior passage 1202. Further, the growth rings 1206 may be rotationally coupled to the plant growing apparatus 100 about the plant axis 1204. In this configuration, a grommet 1208 or the like may be positioned around a top through-hole of a top cover 1210. The grommet 1208 may substantially restrict fluid or the like from exiting the top through-hole while allowing the top cover 1210 to rotate about the plant axis 1204.

A bottom portion 1212 may be coupled to the bottommost growth ring 1206 and be configured to be manipulated by the plant motor 728 to rotate the plant housing assembly 204. More specifically, the bottom portion may have a drain member 1802 (FIG. 9) extending along the plant axis 204 to provide a location for fluid to drain from the interior passage 1202 to the reservoir 310. In one aspect of this disclosure, a cover 1812 may be positioned over the drain member 1802 to manipulate the fluid flow introduced to the reservoir 310. The cover 1812 may act like a funnel to reduce the outlet size and thereby alter the fluid flow pattern of fluid through the bottom portion 1212. The cover 1812 may be configured to reduce splashing caused by fluid entering the reservoir from the bottom portion 1212.

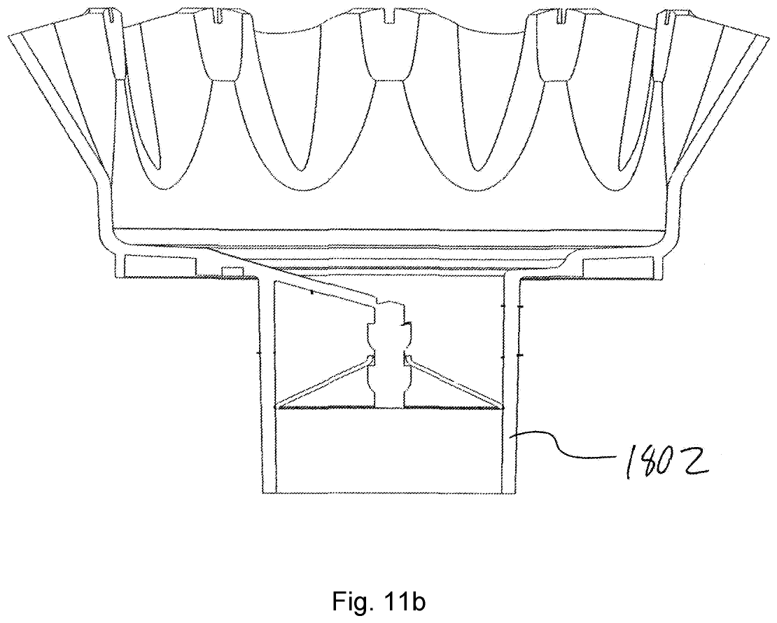

Referring now to FIG. 11b, another embodiment of the drain member 1802 is illustrated. In the embodiment of FIG. 11b, skirt seal may be positioned in the flow path between the interior passage 1202 and the reservoir 310. More specifically, the skirt seal may be a flexible material positioned to prevent back splashing of water from the reservoir 310. The skirt seal may be sufficiently deformable to allow solid matter to freely slide past the skirt seal while still preventing back splashing from the reservoir 310. Further, the skirt seal may substantially prevent pests or the like from entering the interior passage 1202 through the drain member 1802. The skirt seal may also elastically deform when sufficient water pressure is applied thereto and return to its original shape after the water has passed through. The skirt seal may be coupled around a central support that is held concentric with the plant axis 1204 by a rigid arm. In this configuration, the skirt seal is coupleable to the central support and maintained aligned with the plant axis 1204. Accordingly, the skirt seal substantially acts as a one-way valve wherein fluid and debris are allowed to pass out of the interior passage 1202 but otherwise prevents fluid or debris from entering the fluid passage 1202 through the drain member 1802. This also maintains a light tight seal to minimize the exposure of light on the reservoir 310 which reduces the likelihood of undesirable algae growing therein. The skirt may even be a conical spiral to direct water to its center vertical axis while extended below the top of the walls of the reservoir containers. This flexible pultrusion may simply fold over the reservoir container when the drawer is opened and closed to ensure consistent fluid return to the reservoir.

The bottom portion 1212 may also have a strainer 902 or the like positioned over the drain member 1802. The strainer 902 may be sized to substantially cover the drain member and allow fluid to pass from the interior passage 1202 there through and into the drain member 1802. However, the strainer 902 may be sized to substantially restrict plant material from passing there through. In this configuration, the strainer 902 may prevent plant material buildup, such as roots, from blocking the drain member 1802 while allowing fluid to continually flow there through. In one non-limiting example, the strainer 902 may have a dome-like, pyramid-like, or cone-like shape that extends away from the drain member 1802. Further, the strainer 902 may have a plurality of opening sized to allow fluid but not substantial plant matter there through.

In one aspect of this disclosure, a friction reducing mechanism 1214 may be coupled to the bottom portion 1212 between the bottom portion 1212 and the base plate 206. The friction reducing mechanism 1214 may be any mechanism that reduces friction to allow the plant housing assembly 204 to rotate easily about the plant axis 1204. More specifically, the friction reducing mechanism 1214 may be a nylon bushing or the like in one non-exclusive example. Further, in another non-exclusive example the friction reducing mechanism 1214 may be a slew bearing or the like. In yet another embodiment, the bottom portion 1212 may be floating in a fluid and capable of rotating therein. In yet another embodiment, the friction reducing mechanism 1214 may be a magnetic bearing. Accordingly, any known type of friction reducing mechanism is contemplated herein to be utilized between the bottom portion 1212 and the base plate 206.

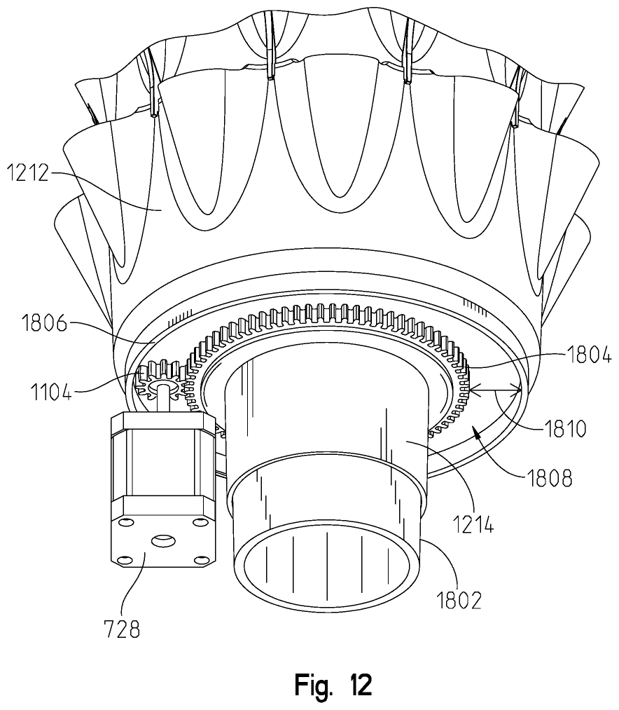

Referring now to FIG. 12, a bottom portion 1212 is illustrated in a perspective view of a bottom side. The bottom side may have the drain member 1802 that is sized to direct fluid to the reservoir 310 and provide for rotating the plant housing assembly 204 about the plant axis 1204. In the embodiment of FIG. 12, the bottom portion 1212 may have gear 1804 embedded therein or otherwise fastened about the plant axis 1204. The gear 1804 may be sized to engage a plant motor gear 1104 coupled to the plant motor 728 to thereby allow the plant motor 728 to rotate the plant housing assembly 204 by interacting with the gear 1804.

In another aspect of the bottom portion 1212 illustrated in FIG. 12 a ring 1806 may be defined about the plant axis 1204. The ring 1806 may be a substantially circular extension from a bottom surface 1808 of the bottom portion 1212. Further, the ring 1806 may be spaced radially away from the embedded gear 1804 a ring distance 1810 that is slightly greater than the diameter of the plant motor gear. In this configuration, the plant motor gear may become positioned in an annular channel of the bottom portion 1212 defined between the gear 1804 and the ring 1806. The ring 1806 may substantially prevent debris or the like from being positioned between the gear 1804 and the plant motor gear as the plant motor 728 rotates the plant housing assembly 204.

In another non-exclusive example, the bottom portion 1212 may have a spiraled extrusion extending from a bottom surface. The spiraled extrusion may have a contact point defined thereon and configured to interact with a solenoid. The solenoid may replace the plant motor 728 and rotate the bottom portion 1212 by pressing the contact point of the spiraled extrusion. In other words, the solenoid may extend and contract on a cyclic pattern to contact the spiraled extrusion and rotate the plant housing assembly 204 with each cycle.

Further still, in yet another embodiment the plant housing assembly 204 may be mechanically coupled to a wind turbine. In this configuration, the wind turbine may rotate when wind acts thereon. Further, the rotation of the wind turbine may be translated to rotate the plant housing assembly 204 via one or more linkage and gear assembly.

The bottom-most growth ring 2102 may be coupled to the bottom portion 1212 by having an overlap section (similar to overlap section 2104) that is radially inside of an outer wall of the bottom portion 1212. Further, each growth ring 1206 may have a similarly sized overlap section 2104 to thereby allow any growth ring 1206 to be coupled to the bottom portion 1212. Further still, the bottom portion 1212 may have notches defined therein to correspond with tabs of the growth rings 1206 and thereby rotationally couple the adjacent growth ring 1206 to the bottom portion 1212 when properly positioned therein.

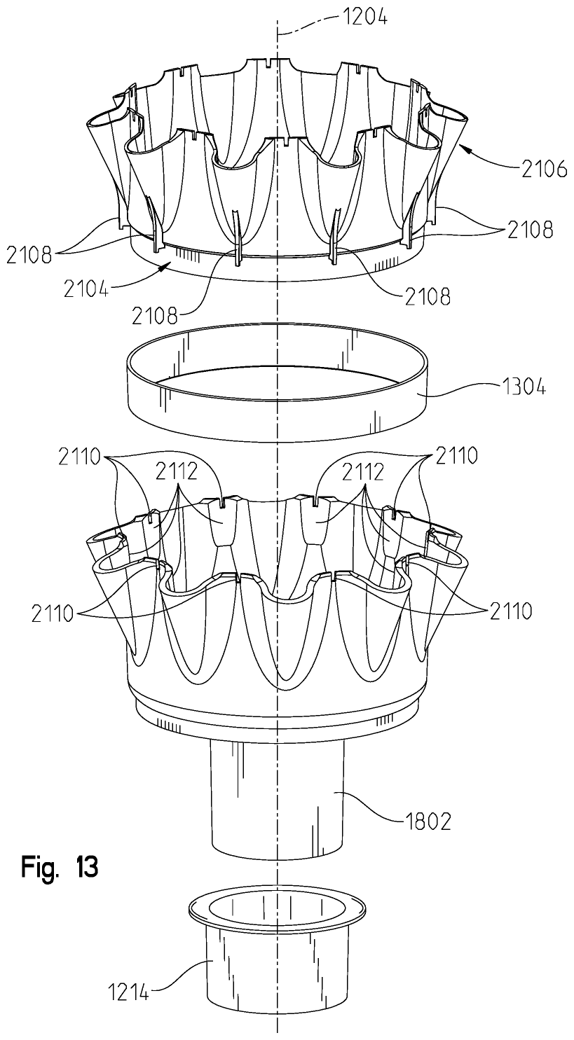

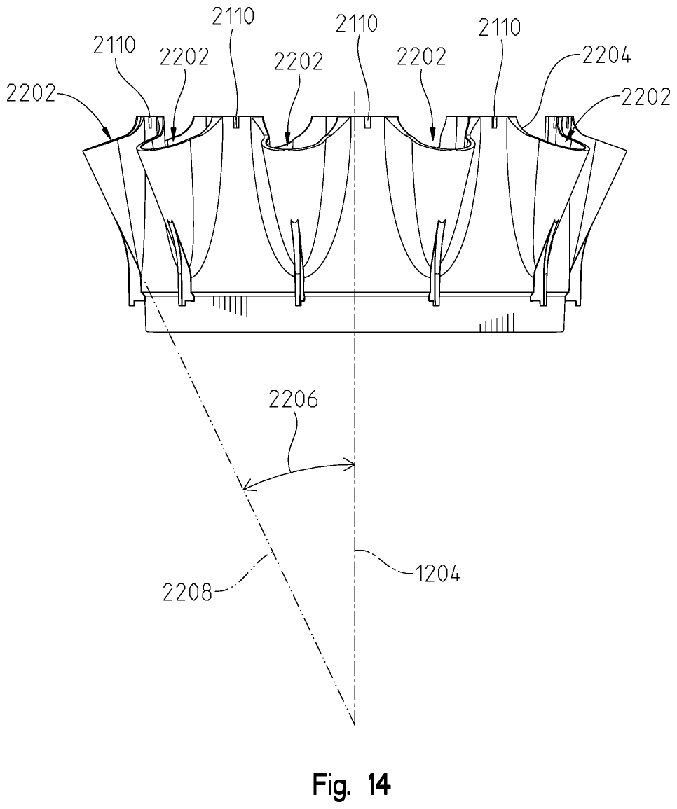

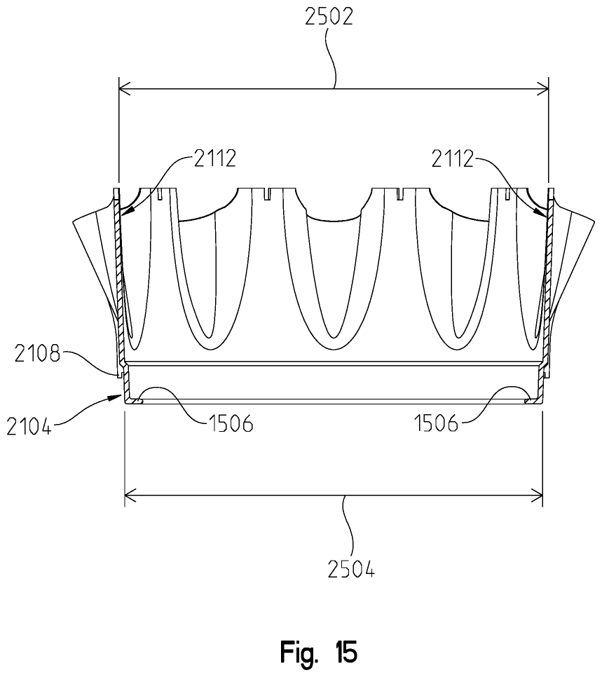

Illustrated in FIG. 13 is a growth ring 2106 spaced axially away from an adjacent growth ring 2106 along the plant axis 1204. Each growth ring 1206 may have at least one a tab 2108 defined along a bottom portion that is sized to correspond with a notch 2110 on the top portion of the adjacent growth ring 2106. The tab 2108 may at least partially extend into the notch 2110 of the adjacent growth ring when the overlap section is positioned within the adjacent growth ring 2106. The overlap section 2104 may contact alignment surfaces 2112 of the adjacent growth ring 2106 when positioned therein to ensure that adjacent growth rings 2106 remain coaxial with the plant axis 1204. This may also be a pin and hole connection, threaded screw connection, or other method of fastening these rings together.

Further, when adjacent growth rings 2106 are properly coupled to one another, the tabs 2108 may be at least partially positioned within the corresponding notches 2110 to substantially rotationally couple the adjacent growth rings 2106 to one another. In other words, when adjacent growth rings 2106 are properly coupled to one another, the contact between the overlap section 2104 and the alignment surface 2112 may maintain the coaxial alignment of the growth rings 2106 while the contact between the tabs 2108 and the notches 2110 may rotationally couple the growth rings to one another.

Similarly, the overlap section 2104 may ensure that any fluid dispersed by the nozzle 1302 is maintained within the interior passage 1202 until the fluid reaches the drain member 1802 of the bottom portion 1212. In one aspect of this disclosure, the overlap section may have a bottom lip 1506 that extends radially inward therefrom. The bottom lip 1506 may further prevent fluid from escaping the interior passage 1202 by directing the fluid towards the plant axis 1204. In other words, the growth rings 1206 nest into one another so that fluid dispersed in the interior passage 1202 will naturally flow to the bottom portion and then into the reservoir 310.

In another aspect of this disclosure, a gasket 1304 or the like may be positioned around the overlap section 2104 to further ensure adjacent growth rings 2106 are properly coupled to one another. The gaskets 1304 may be substantially cylindrical and positioned between the overlap section 2104 and the alignment surface 2112. The gaskets 1304 may be formed of a silicon or the like material. Further, the gaskets 1304 may be antimicrobial to ensure the gaskets 1304 maintain a sterile environment along the interior passage.

Referring now to FIGS. 21-25, the form of the growth rings 1206 is explained in more detail. More specifically, the upper-most portion of each growth ring 1206 may have a first inner diameter 2502 defined by the alignment surfaces 2112. The first inner diameter 2502 may be about the same as a second outer diameter 2504 of the overlap section 2104. In this orientation, adjacent growth rings 1206 may be coupled to one another as described herein. Further still, the alignment surfaces 2112 may be configured to elastically deform radially away from the plant axis 1204 responsive to contact with the overlap section 2104. Accordingly, the overlap section 2104 can be forced into the alignment surfaces 2112 to thereby cause the alignment surfaces 2112 to expand radially away from the plant axis 1204 and thereby frictionally coupled the growth rings 1206 to one another.

In the embodiment that utilizes gaskets between the alignment surfaces 2112 and the overlap section 2104 the first inner diameter 2502 and the second outer diameter 2504 may be correspondingly sized. More specifically, if the gasket has a one-eighth inch thickness, the two diameters 2502, 2504 may be sized to allow for about a one-eight inch gasket to fit there between.

Further, each growth ring 1206 may have a single or plurality of plant openings 2202 defined therein. Each plant opening 2202 may be configured to accommodate a plant pod therein to position at least a portion of the plant pod at least partially within the interior passage 1202. The plant openings 2202 may be shaped from portions of a growth ring wall 2204 that are radially expanded from the plant axis 1204. More specifically, each plant opening may be a radial expansion that has an outer profile that defines an axis 2208 that is angled at plant opening angle 2206 relative to the plant axis 1204. However, many different angels are considered herein that affect the angle of pod orientation that may affect exposure to the growth light and the irrigation solution among other things. Accordingly, as the plant opening 2202 approaches that uppermost portion of the growth ring 1206, the plant opening 2202 may extend farther radially away from the plant axis 1204. In this orientation, the plant pods can be easily placed and maintained in the plant openings 2202.

In other words, the plant openings 2202 may be formed from a circular wave-like pattern defined in by the growth ring wall 2204 along the perimeter. In this configuration, the growth rings 1206 may be formed from injection molding or be stamped in a die. However, any other known manufacturing process is also considered herein, and this disclosure considers any known method of manufacturing the growth rings 1206.

Within each plant opening 2202 there may be a filter. These filters may be inside, around, or embedded into the seed pods. In one embodiment, the filters are semi-permeable membranes which allow moisture to enter the seed pod root chamber without affecting the chemical composition of the water outside the seed pod. These filters may be composed of: paper, PLA or other woven on non-woven polymer mesh, PVA (Polyvinyl Alcohol) hydrogel based films or the like to allow the permeability of nutrient solution while excluding larger things such algae, pathogens, or other undesirable things. Additionally, the filters may create a specific root zone for individual crops. This root zone may create agronomist properties optimized for individual plant species to achieve a poly-culture configuration of different crop types. The filters may be composed of filter paper, or combined with plant based polymers and fibers. The filters may biodegrade throughout the life cycle of the plant as the plant consumes the filter and as the roots expand.

Growing inputs—such as seed, growing media, fertilizer, pesticides, or any combination of these materials and/or other inputs or accelerants—may be placed within these filters. Further, these inputs may be time-released. In one example, pH buffers could be coated in responsive polymers that dissolve in the contact of, or during specific environmental parameters. More specifically, an acidic solution may cause capsules to dissolve that release a base to raise the pH value of the seed pod root zone, or the release may bring the entire hydroponic chamber back to optimal levels for plant cultivation. In another example, alkaline capsules may be released if pH values of the seed pod root zone or entire hydroponic system becomes too acidic. These may also include growing media, animal repellant, soil enhancer, soil enricher, fertilizer, bone meal, plant growth hormones, cinnamon, sand, adjuvants, moisture absorbent, ribose, or pesticides among other possible additives within the seed pod.

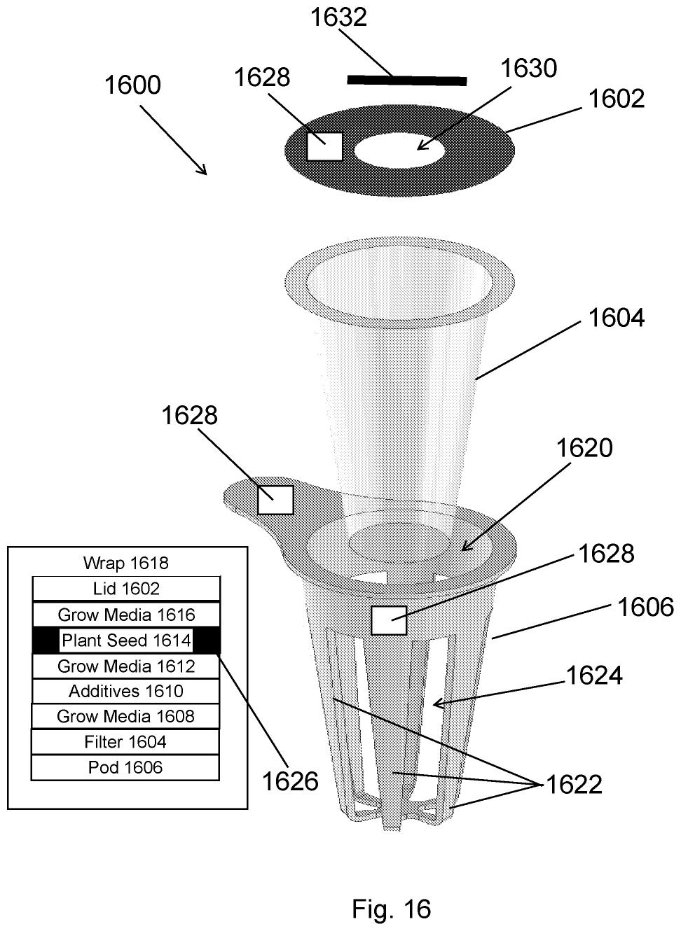

Referring now to FIG. 16, one non-exclusive example of a seed pod assembly 1600 is illustrated along with a schematic view of a layered seed pod. The seed pod assembly 1600 may have a seed pod 1606 that provides a structural basis for the assembly. The pod 1606 may be a structural member that can support contents in an interior region 1620 while allowing water, nutrients, and the like to access the interior region 1602. More specifically, support segments 1622 may extend from an opening end to a base end and provide spacing there between. The support segments 1622 are spaced to provide at least one opening 1624 such that they can adequately support the contents of the interior region 1620 while still allowing water, nutrients, and the like to enter the interior region 1602 through the at least one opening 1624. That is to say, the support segments 1622 do not entirely enclose the interior region 1620.

While a particular structure is illustrated for allowing water, nutrients, and the like to enter the interior region 1620 (i.e. the spaced support segments), other structures are considered herein as well. For example, instead of support segments 1622, solid walls of the interior region 1620 could have holes there through to allow water and nutrients to enter the interior region 1620. Alternatively, the walls of the interior region could be made of a permeable mesh material or the like. Accordingly, this disclosure contemplates using any structure for the wall of the interior region 1620 that will support the contents of the interior region 1620 and allow water, nutrients, and the like to enter the interior region 1620.

In one non-exclusive manufacturing method of the seed pod assembly 1600, a filter 1604 may be placed and pressed into the interior region 1620 of the pod 1606. In one aspect of this disclosure, the filter 1604 may be a paper based, fabric, woven mesh, PLA nonwoven mesh, or any other similar material. Other embodiments may implement a selective moisture vapor-permeable film (moisture vapor-permeable film of penetration-vaporization type) which is water-impermeable as the filter 1604 material. Also considered herein for the filter is a nonporous hydrophilic polyvinyl alcohol (PVA) film.

After the filter 1604 is positioned, a first specific amount and type of grow media 1608, or other additive may be inserted into the cavity of the filter 1604 in the pod 1606. Next, another grow media 1608 or additive mixture 1610 that can be any one or more of fertilizer, pH buffers, microbes, pesticides, adjuvants, animal repellant, soil enhancer, soil enricher, bone meal, plant growth hormones, cinnamon, sand, moisture absorbent, ribose, microbial inoculants, detergent, cleaning solution, vinegar, hydrogen peroxide, soap, and fungicides among other potential additives may be inserted into the cavity of the filter in the pod 1606 adjacent to the grow media 1608. In a next layer, a second specific amount and type of grow media 1612 may be inserted into the pod. A plant seed 1614 may then be placed in the filter cavity of the pod on the last layer of grow media 1612. There may be seed positioning member 1626 that is a layer of a foam or other material that fixes the seeds into a singular position that may be disc shaped. This foam, or other material that fixes the layer position, may be placed under, around, over, or in any combination of layers about the seed(s). In one aspect of this disclosure, the seed positioning member 1626 may be disc shaped with a center cutout sized to correspond with an expected seed dimension. In yet another aspect of this disclosure, the seed positioning member 1626 may contain a hydrogel or the like.

The plant seed 1614 may be placed in the seed positioning member and the seed positioning member may be placed in the interior region 1620 in one of the layer configurations discussed herein. The seed positioning member may substantially hold the seed in the desired location within the interior region until germination begins.

A third specific amount and type of grow media 1616 may then be inserted into the filter cavity of the pod. In other embodiments contemplated herein, the seed pod may be one or more layers of various combinations of grow media, seeds, and/or additives. Next, all of the seed pod contents may be lightly compressed into the filter cavity in the seed pod and a lid 1602 may be sealed or otherwise coupled to the top of the seed pod 1606. Finally, the seed pod 1606 may be wrapped with heat shrink or otherwise encapsulating material wrap 1618 to completely seal the pod from ambient humidity conditions. The wrap 1618 may be compostable, and/or water soluble, among other potential characteristics. The seed pod assembly 1600 may be color coded to aid in identifying the proper location of the seed pod based on expected plant size.

In one contemplated embodiment, an amount of material is added within the pod 1606 to provide a thermal retaining mass that can be cooled prior to planting the pod 1606. This may provide improved germination rates among other things. The thermal retaining mass may be a hydrogel based material that rapidly expands and becomes saturated for maximum thermal capacity among other materials.

The term “layer” is used herein with reference to the contents of the grow pod 1606. However, the grow media 1610, additives 1610, and/or plant seed 1614 may not be in planar layers. Rather, the contents of the “layer” may be partially affected by the contours of the underlying surface such as the bottom of the pod 1606. Further, the layers such as the grow media 1608 and additives 1610 may at least slightly intermix when being placed in the seed pod assembly 1600. As such, the term “layer” refers to the positioning of the corresponding material relative to the underlying material and may take many different physical forms.

In another aspect of this disclosure, the filter 1604 of the seed pod assembly 1600 may be applied with adhesives or be melted between the aluminum lid 1602 and the plastic pod 1606 in a sandwich-type configuration wherein the materials with plastic fibers of the filter 1604 melt into a sealed pod 1606 with the aluminum lid 1602. This filter paper could also be treated to prevent fungal or algae growth. However, this lid material could also be a paper, polymer, or other material that is sealed to the cup via sonic welding, high pressure, or other methods.

The lid 1602 may attach to the seed pod 1606 with adhesive substances, heat applied to a metallic lid to melt to the polymer and cup, sonic welding to fuse the parts, or any other method to adhere a barrier to the pod 1606. The lid 1602 may help reduce algae growth on the growing media by shading the content of the seed pod assembly 1600, the lid 1602 may help the seed pod assembly 1600 maintain a higher humidity level, and the lid 1602 may help identify the plant species name. The user may be instructed to puncture the lid 1602, or even pull the lid 1602 open through a removable tab.

In one aspect of this disclosure, the lid 1602 may contain a covering 1632 such as a pull tab over a substantially central orifice 1630. The user may be instructed to pull the tab of the covering 1632 away from the seed pod 1606 as part of the seed pod assembly 1600 placement process. In doing so, the lid 1602 may deform outwardly away from seed pod 1606 as the pull tab is removed. This may create an outward taper of the lid about the orifice 1630 that encourages the germinating plant to grow partially through the orifice 1630. Alternatively, the lid 1602 may have a dome shape or be otherwise convex shape away from the seed pod 1606 to direct the germinating plant through the orifice 1630 of the lid 1602 during use. Further still, in one embodiment considered herein the covering 1632 is made from a dissolvable material and the orifice 1630 may become exposed when the lid 1602 is exposed to water.

A hot plate press process, heat and pressure press, or induced electric current may be used to permanently melt the lid 1602 into the pod 1606 among other adherence methods. The lid 1602 may identify the plant species with an identifier 1628. The identifier 1628 may be configured to identify the type of plant associated with the plant seed 1614 in the seed pod assembly 1600. The identifier 1628 may utilize any known method to identify the type of plant seed 1614 in the seed pod assembly 1600. As some contemplated examples, the identifier 1628 may be printed on the lid 1602, affixed to the lid 1602 or other portion of the pod assembly 1600 via a sticker, and/or a QR code or bar code on the lid 1602 or other portion of the pod assembly 1600. In yet another embodiment, the identifier may be a fluorescent material, penetrating wavelength reflective material, or passive/active chip on the lid 1602 or any other portion of the seed pod assembly 1600. Further still, the identifier 1628 may be an RFID tag coupled to the lid 1602 or other portion of the seed pod assembly 1600.

The identifier 1628 may be detectable by a person, the camera 214, a dedicated RFID receiver, Lidar, or any other similar sensor. Each seed pod may have one or more handle or radial tab 1708. The radial tab 1708 may allow the user to lift and place the seed pod assembly 1600 more easily, and may prevent the seed pod assembly 1600 from falling into the tower. The lid 1602 may be composed of compostable or biodegradable materials.

The lid 1602 may also have a distinct color thereon intended to be associated with a corresponding color of the plant housing assembly 204. More specifically, each growth ring 1206 may have a specific color associated with the order for which it is positioned on the plant housing assembly 204. The color on the growth ring 1206 may identify the size of plant that may ideally be positioned in that particular growth ring 1206. For example, the bottom most growth ring 1206 may have a color associated with larger plants to allow space for growth while the top most growth ring 1206 may have a color associated with smaller plants. The lids 1602 may be similarly color coded to correspond with a color of the growth rings 1602 to identify to the user the proper placement location of the grow pod assembly 1600.

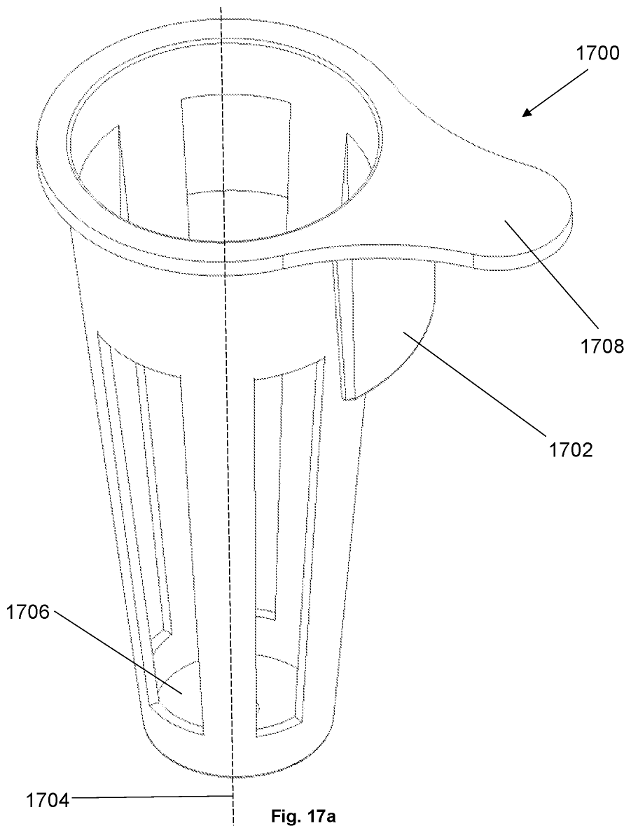

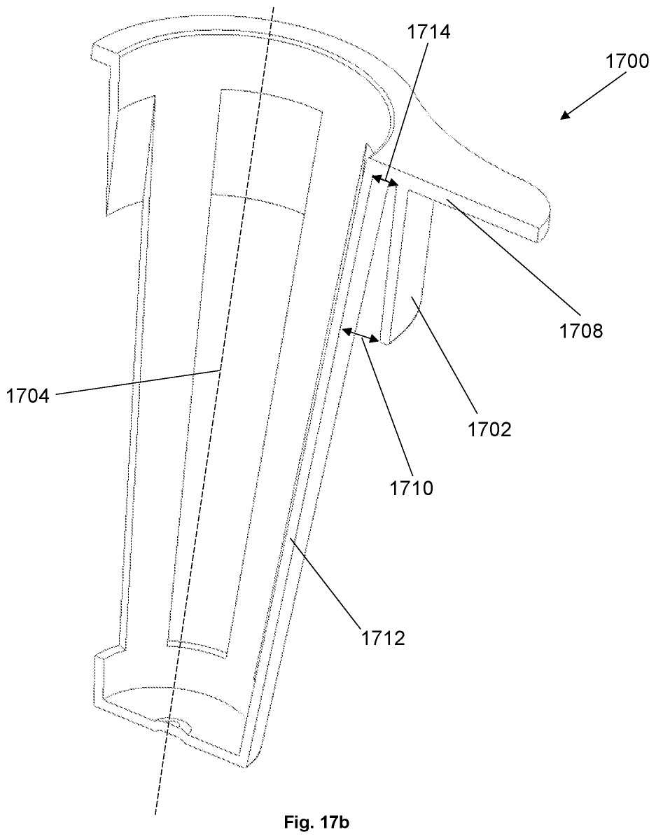

Referring now to FIGS. 17a and 17b, another embodiment of a seed pod structure 1700 is illustrated. The pod 1700 may be substantially similar to the pod 1606 but have a retention tab 1702 defined therein. As such, the pod 1700 may be a substitute for the pod 1606 discussed herein and be filled and packaged as discussed herein with reference to FIG. 16. The pod 1700 is configured to be positioned in one of the plant openings 2202. The plant openings 2202 may be formed, in part, by an upper growth ring 1206. In this configuration, the seed pod assembly 1600 may have a propensity to fall out of the plant opening 2202 when the upper growth ring 1206 is moved away from or removed from the plant housing assembly 204 because the radially inner portion of the plant opening 2202 is no longer backed by the upper growth ring 1206. Accordingly, the pod 1700 positions the retention tab 1702 to at least partially overlap a portion of the underlying growth thing 1206 when properly positioned in a plant opening 2202.

More specifically, the retention tab 1702 may extend axially relative to a pod axis 1704 towards a bottom 1706 of the pod 1700. The retention tab 1702 may be at least partially positioned underneath a radial tab 1708 that extends radially away from the axis 1704. In this configuration, the radial tab 1708 may be a location that can be grasped by a user to facilitate removal of the lid 1606. Further, the radial tab 1708 may provide a location where the user can hold the seed pod assembly 1600 to position it within a corresponding opening 2202. Accordingly, the radial tab 1708 will typically be oriented away from the plant axis 1204 as the user places the seed pod assembly 1600 in the corresponding opening 2202. As such, by positioning the retention tab 1702 at least partially under the radial tab 1708, the retention tab 1702 will typically be positioned along a radially outer portion of the opening 2202 relative to the plant axis 1204 where the retention tab 1702 will be adjacent to a portion of the underlying growth ring 1206. In this configuration, the retention tab 1702 may also substantially prevent the seed pod 1700 from substantially rotating within the corresponding opening 2202. Alternatively, in other configurations considered herein the seed pod may have a keyed cross section that matches that of the opening 2202 and the keyed cross section may substantially prevent the seed pod from rotating within the opening.

The retention tab 1702 may be spaced a first distance 1710 from an adjacent member 1712 of the pod 1700 at a terminus of the retention tab 1702. The first distance 1710 may be sufficiently wide to allow at least a portion of a growth ring 1206 to be positioned therein when the pod 1700 is properly positioned in an opening 2202. Further, the retention tab 1702 may taper inwardly as it approaches the radial tab 1708. That is to say, the retention tab 1702 is spaced a second distance 1714 from the adjacent member 1712 where the retention tab 1702 meets the radial tab 1708. This inward taper may allow the retention tab 1702 to frictionally contact the portion of the growth ring 1206 positioned between the retention tab 1702 and the adjacent member 1712 when the pod 1700 is properly positioned in the opening 2202. This frictional contact may substantially hold the pod 1700 in the opening 2202 even if the upper adjacent growth ring 1206 is removed.

While a tapered opening between the retention tab 1702 and the adjacent member 1712 is discussed herein, other embodiments may not have a tapered opening. In one example, the retention tab 1702 may extend substantially parallel to the adjacent member 1712. Accordingly, this disclosure contemplates both tapered openings and non-tapered openings between the retention tab 1702 and the adjacent member 1712.

Any of the components discussed herein may be formed from a molding process that implements antimicrobial additives during the injection molding process or otherwise to kill pathogens on contact. Implementing these additives may inhibit the growth of damaging microorganisms anywhere in the plant growing apparatus 100. More specifically, when microbes come in contact with the surface of the compartment made with this technique, the additives penetrate the cell wall of the microorganism and disrupts cell functions making the microorganism unable to function, grow and reproduce.

One or more indicator(s) may also be positioned along a visible surface of the plant growing apparatus 100. The indicator may be one or more of a button/buttons, light indicators, touchscreen, LCD screen, other visual displays, buzzer, speaker, microphone, and any other components that allow users to interact with the device. The indicator light may identify information regarding the running state of the apparatus 100. For example, a “green light” may indicate the apparatus is operating as expected. Further, a different color or blinking pattern may indicate a spray cycle is in progress. The indicator light may also notify the user that something needs to be maintained. Additionally, the indicator light could provide a signal to protect the user from disrupting a growth cycle in which the spray nozzle is spraying among other things.

The number of plant openings 2202 defined by the growth ring 1206 may vary depending on the type of plant being positioned therein. Accordingly, a growth ring for large plants may have fewer plant openings than a growth ring for smaller plants. Similarly, any number of growth rings 1206 may be coupled to one another to form the plant housing assembly 204 to accommodate the height of the plant growing apparatus 100. For example, a taller plant growing apparatus 100 may require a greater number of growth rings 1206 than a comparatively shorter growing apparatus 100. The number of growth rings 1206 can be any number sufficient to allow the interior passage 1202 to extend from the top cover 1201 to the bottom portion 1212. Further, cylindrical spacers may also be utilized therein to provide the proper axial distance between the top cover 1201 and the bottom portion 1212 when plant openings are not needed the entire height of the plant housing assembly. In one aspect of this disclosure, a stopper may be positioned in any of the plant openings 2202 that are not filled with a pod. These pods can be inert, or be dissolvable with cleaning solvents that may eradicate undesirable microbial growth without harming the plants.

In one non-exclusive example of an application of the present disclosure, a user may purchase a plant growing apparatus 100 and install it in a base cabinet space similar to a mini-refrigerator or the like. The power supply 724 may be electrically coupled to a local power grid and a water source may be selectively coupled to the reservoir 310 via the controller. The user may then stack the appropriate number and type of growth rings between the top cover 1201 and the bottom portion 1212. Next, the user may populate the plant openings of the growth rings with the types of plant pods the user intends to grow. The controller 726 may automatically identify the plant pods positioned therein by communicating with the plant pods via wireless communication. Next, the controller 726 may utilize the fluid and electrical systems described herein to generate an interior 202 that is ideal for growing the plants identified in the plant pods.

In another embodiment of this disclosure, the drain member 1802 may be sized to fit into a standard conduit fitting. As one non-exclusive example, the drain member 1802 may fit into a T-type polyvinyl chloride (“PVC”) connector. In this configuration, a PVC drainage conduit can be formed with one or more T-type fittings that allow the drain members 1802 to be coupled thereto. Accordingly, several plant housing assemblies 204 may be fluidly coupled to a single drainage conduit. Further still, each plant housing assembly 204 may have a nozzle 1302 that provides fluid to each plant housing assembly 204 to plants individually, or the entirety of the growing column. The plant housing assemblies 204 may be fixedly coupled to the drainage conduit and further a support line may provide additional support to the plant housing assemblies 204 and fluid lines for the nozzles 1302. In this embodiment, any number of plant housing assemblies 204 may be fluidly coupled to the drainage conduit and fluid lines.

While this disclosure has been described with respect to at least one embodiment, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this pertains and which fall within the limits of the appended claims.

While the disclosure has been illustrated and described in detail in the drawings and foregoing description, such illustration and description is to be considered as exemplary and not restrictive in character, it being understood that illustrative embodiment(s) have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

1. A seed pod assembly, comprising:
a pod defining an interior region and configured to support contents therein;
a grow media positioned at least partially within the interior region;
a plant seed positioned at least partially within the interior region;
a lid coupled to the pod to contain the plant seed within the interior region; and
an additive layer in the interior region, the additive layer positioned between two grow media layers;
wherein, the pod is sized to be positioned in an opening of a plant growing apparatus to allow water and nutrients to reach the plant seed or be released from within the pod.

2. The seed pod assembly of claim 1, wherein the pod has support segments separated by at least one opening, wherein the opening allows water, plant roots, and nutrients to enter and exit the interior region.

3. The seed pod assembly of claim 1, further comprising a filter positioned along at least a portion of walls of the interior region to provide a filter barrier between the interior region and a surrounding environment.

4. The seed pod assembly of claim 3, further wherein the grow media and plant seed are positioned at least partially within the filter in the interior region.

5. The seed pod assembly of claim 1, comprising additives in the interior region, wherein the additives are one or more of fertilizer, pH buffers, microbes, pesticides, adjuvants, animal repellant, soil enhancer, soil enricher, bone meal, plant growth hormones, cinnamon, sand, moisture absorbent, ribose, microbial inoculants, thermal retaining mass, detergent, cleaning solution, vinegar, hydrogen peroxide, soap, and fungicides.

6. The seed pod assembly of claim 1, further comprising a seed positioning member positioned around the plant seed and configured to hold the plant seed in a specific location in the interior region.

7. The seed pod assembly of claim 6, wherein the seed positioning member is formed of a different material than the grow media.

8. The seed pod assembly of claim 6, wherein the seed positioning member is formed of foam.

9. The seed pod assembly of claim 1, further comprising a wrap around the seed pod assembly, the wrap configured to entirely surround the seed pod assembly and protect the contents of the seed pod assembly from the surrounding environment until the wrap is removed before the seed pod assembly is placed in the opening of the plant growing apparatus.

10. The seed pod assembly of claim 1, wherein the additive layer is in contact with the plant seed.

11. The seed pod assembly of claim 3, further wherein a portion of the filter is positioned at least partially between the lid and the pod and the lid is coupled to the pod to at least partially retain the filter therein.

12. The seed pod assembly of claim 1, comprising a retention tab coupled to or formed from the pod and configured to at least partially overlap a wall defining the opening when positioned therein.

13. The seed pod assembly of claim 12, wherein the retention tab has an inward taper configured to frictionally engage the wall of the opening when positioned therein.

14. The seed pod assembly of claim 12, further comprising a radial tab extending radially away from a pod axis, the retention tab being positioned at least partially adjacent to the radial tab.

15. The seed pod assembly of claim 14, further wherein the retention tab extends from a surface of the radial tab.

16. The seed pod assembly of claim 1, further comprising an identifier configured to identify the type of plant seed in the seed pod when the seed pod is positioned in the opening of a plant growing apparatus.

17. The seed pod assembly of claim 16, further wherein the identifier is on the lid.

18. The seed pod assembly of claim 16, further wherein the identifier is an RFID tag.

19. The seed pod assembly of claim 18, further wherein the RFID tag is positioned on a radial tab extending radially away from a pod axis.

20. The seed pod assembly of claim 1, further wherein one or more of the pod and the lid have a color configured to be associated with a corresponding opening of the plant growing apparatus.

21. A method for forming a seed pod assembly, comprising:
positioning a filter in an interior region of a pod;
inserting a first grow media layer into a cavity of the filter in the interior region of the pod;
placing a plant seed in the cavity of the filter on the first grow media layer;
inserting a second grow media layer into the cavity of the filter adjacent to the plant seed; and
compressing the contents of the interior region into the filter cavity as a lid is coupled to a top portion of the pod.

22. The method of claim 21, further comprising adding an additive mixture and a third grow media layer wherein the additive mixture is positioned between the first grow media layer and the third grow media layer.

23. The method of claim 22, wherein the additive mixture is one or more of fertilizer, pH buffers, microbes, pesticides, adjuvants, animal repellant, soil enhancer, soil enricher, bone meal, plant growth hormones, cinnamon, sand, moisture absorbent, thermal retaining mass, ribose, microbial inoculants, detergent, cleaning solution, vinegar, hydrogen peroxide, soap, and fungicides.

24. The method of claim 21, further wherein the placing a plant seed step comprises positioning the plant seed in a seed positioning member to hold the plant seed in the desired orientation within the interior region, the seed positioning member being a different material than the first and second grow media layer.

25. The method of claim 21, further comprising wrapping the seed pod assembly with a material wrap to completely seal the interior region of the seed pod assembly from the surrounding environment.

26. The method of claim 21, further wherein the coupling the lid to the top portion of the pod step comprises melting at least a section of the filter between the lid and the pod in a sandwich-type configuration wherein the materials of the filter melt into the pod.

27. The method of claim 21, further comprising forming an orifice in the lid and positioning a covering over the orifice, the covering being at least partially removable from the lid to expose the orifice.

28. The method of claim 27, further wherein the covering is dissolvable.

29. A method for forming a seed pod assembly, comprising:
positioning a filter in an interior region of a pod;
inserting a first grow media layer into a cavity of the filter in the interior region of the pod;
placing a plant seed in the cavity of the filter on the first grow media layer;
inserting a second grow media layer into the cavity of the filter adjacent to the plant seed;
adding an additive mixture and a third grow media layer wherein the additive mixture is positioned between the first grow media layer and the third grow media layer; and
coupling a lid to a top portion of the pod.

30. A method for forming a seed pod assembly, comprising:
positioning a filter in an interior region of a pod;
inserting a first grow media layer into a cavity of the filter in the interior region of the pod;
placing a plant seed in the cavity of the filter on the first grow media layer by positioning the plant seed in a seed positioning member to hold the plant seed in the desired orientation within the interior region, the seed positioning member being a different material than the first and second grow media layer;
inserting a second grow media layer into the cavity of the filter adjacent to the plant seed; and
coupling a lid to a top portion of the pod.

31. A method for forming a seed pod assembly, comprising:
positioning a filter in an interior region of a pod;
inserting a first grow media layer into a cavity of the filter in the interior region of the pod;
placing a plant seed in the cavity of the filter on the first grow media layer;
inserting a second grow media layer into the cavity of the filter adjacent to the plant seed; and
coupling a lid to a top portion of the pod by melting at least a section of the filter between the lid and the pod in a sandwich-type configuration wherein the materials of the filter melt into the pod.

32. A method for forming a seed pod assembly, comprising:
positioning a filter in an interior region of a pod;
inserting a first grow media layer into a cavity of the filter in the interior region of the pod;
placing a plant seed in the cavity of the filter on the first grow media layer;
inserting a second grow media layer into the cavity of the filter adjacent to the plant seed; and
coupling a lid to a top portion of the pod; and
forming an orifice in the lid and positioning a covering over the orifice, the covering being at least partially removable from the lid to expose the orifice.
